(19) United States
(12) Patent Application Publication
(10) Pub. No.: US 2008/0250888 A1
(43) Pub. Date: Oct. 16, 2008

(54) Reduction gear for electric power-steering apparatus

(76) Inventors: Dong-heon Ha, Gunpo (KR); Seong-soo Kim, Seoul (KR); Sang-ho Bang, Cheonan (KR)

Correspondence Address: HARNESS, DICKEY & PIERCE, P.L.C., P.O. BOX 828, BLOOMFIELD HILLS, MI, 48303, US

(21) Appl. No.: 12/080,934

(22) Filed: Apr. 7, 2008

(30) Foreign Application Priority Data
Apr. 10, 2007 (KR) 10-2007-0034996

(51) Int. Cl. F16H 1/16

(52) U.S. Cl. 74/425

(57) ABSTRACT

Disclosed is a reduction gear for an electric power steering apparatus, wherein the worm of the reduction gear does not substantially suffer from dimensional deformation caused by moisture absorption and increase of rotational torque caused by the dimensional deformation without substantially deteriorating the strength and wear resistance as compared to those of a conventional worm. The reduction gear includes a worm wheel formed from a metallic material; and a worm installed to engage with the worm wheel, the worm being formed from a material containing PA12 as main component and glass fiber as reinforcement component.

### CROSS-REFERENCE TO RELATED APPLICATION

This non-provisional application claims priority under 35 U.S.C § 119(a) on Patent Application No. 10-2007-0034996 filed in Korea on Apr. 10, 2007, the entire contents of which are hereby incorporated by reference.

### BACKGROUND OF THE INVENTION

1. Field of the Invention

The present invention relates to a reduction gear for an electric power-steering apparatus, which includes a worm wheel and a worm and has a remarkably improved dimensional stability.

2. Description of the Prior Art

Among power steering apparatuses for ensuring stability in steering condition of a vehicle, an electric power steering apparatus generally transmits steering power obtained from the power of an electric motor to a steering shaft.

Such an electric power steering apparatus drives a motor through an electronic control unit according to a driving condition of a vehicle sensed by a vehicle speed sensor, a steering torque sensor, etc. As a result, the electric power steering apparatus is capable of providing a driver with optimum steering conditions by affording a light and convenient steering feeling when the vehicle is driven at low speed, by affording good directional stability in addition to a heavy steering feeling when the vehicle is driven at high speed, and by enabling rapid steering under an emergency situation.

A conventional electric power steering apparatus includes a reduction gear for reducing and transmitting the driving power of a motor to a steering shaft, wherein the reduction gear typically includes a worm wheel mounted on the steering shaft and a worm connected to the motor shaft. The worm wheel is formed from metal, particularly steel, whereas the worm is formed of a synthetic resin so as to cope with high frictional resistance between the worm and the worm wheel.

In particular, a polyamide material selected from PA6, PA66 and PA46 is employed as a material for such a worm. However, the worm formed from such a polyamide material has a problem in that the teeth of the worm are excessively deformed under high temperature and high humidity. As a result, the performance of the reduction gear is deteriorated due to rotational torque increased according to the excessive deformation of the worm. It has been found that the deformation of the worm teeth is caused because the worm is formed from a material with a high hygroscopic property, such as PA6, PA66, PA46, etc.

### SUMMARY OF THE INVENTION

Accordingly, the present invention has been made to solve the above-mentioned problems occurring in the prior art, and the present invention is to provide a reduction gear for an electric power steering apparatus, wherein the worm of the reduction gear does not substantially suffer from dimensional deformation caused by moisture absorption and increase of rotational torque caused by the dimensional deformation without substantially deteriorating the strength and wear resistance as compared to a conventional worm.

In order to accomplish this object, there is provided a reduction gear for an electric power steering apparatus for reducing and transmitting power of a motor to a steering shaft, wherein the reduction gear includes a worm wheel formed from a metallic material, and a worm installed to engage with the worm wheel, the worm being formed from a material containing PA12 as a main component and glass fiber as a reinforcement component. PA12 has a very low moisture absorptance as compared to the other PA resins. Consequently, if PA12 is employed as the material of the worm, it is possible to highly suppress or reduce the deformation of the worm teeth, which has been a problem in existing reduction gears. In addition, although PA12 is poor in strength as compared to the other PA resins, the worm containing PA12 as main component is not poor in strength as compared to the worms of the existing reduction gears if it is reinforced with glass fiber.

The material of the worm contains PA12 preferably in the range of 70 to 95 wt % of PA12, more preferably in the range of 80 to 90 wt %, and glass fiber, preferably in the range of 5 to 30 wt %, more preferably in the range of 10 to 20 wt %. If the content of glass fiber exceeds 30 wt %, wear resistance is greatly deteriorated and moisture absorptance is also increased. In addition, if the content of glass fiber is less than 5 wt %, it is impossible for the worm to meet a proper strength requirement for a reduction gear. Through various tests, it has been found that when glass fiber in the range of 10 to 20 wt % is mixed with PA12, the deformation of the worm teeth caused by moisture absorption can be suppressed without substantially deteriorating the strength and wear resistance of the worm. It has been also found that when the glass fiber includes staple fibers with a length in the range of 3 to 4 mm and a diameter of 10 μm, moldability and other physical properties can be improved.

### BRIEF DESCRIPTION OF THE DRAWINGS

The above and other objects, features and advantages of the present invention will be more apparent from the following detailed description taken in conjunction with the accompanying drawings, in which:

FIG. 1 is a schematic view for illustrating a reduction gear for an electric power steering apparatus according to an embodiment of the present invention; and

FIGS. 2 to 8 are graphs for illustrating dimensional stability of a worm of a reduction gear.

### DETAILED DESCRIPTION OF THE PREFERRED EMBODIMENTS

Hereinafter, a preferred embodiment of the present invention will be described with reference to the accompanying drawings.

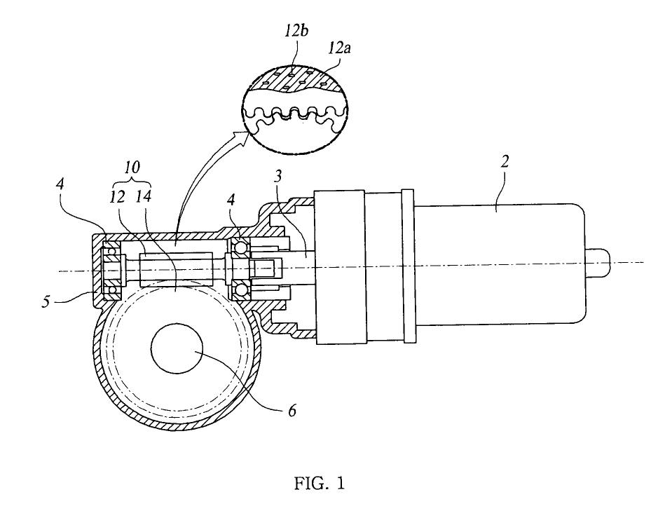

FIG. 1 is a schematic view for illustrating a reduction gear for an electric power steering apparatus according to an embodiment of the present invention. FIG. 1 shows a motor 2, a steering shaft 6, and a reduction gear 10 for receiving power from the motor 2 and transmitting the power to the steering shaft 6 after reducing the power. In addition, the reduction gear 10 and the steering shaft 6 are incorporated within a housing 5 coupled to the motor 2, wherein the steering shaft 6 serves as a rotary shaft of the reduction gear 10.

The reduction gear 10 includes a worm 12 and a worm wheel 14 engaging with the worm 12. The shaft of the worm 12 is rotationally supported by bearings 4 provided in the housing 5. The worm wheel 14 is formed from a metallic material, preferably a steel material, and is mounted on the steering shaft 6. The steering shaft 6 and the shaft of the worm 12 are arranged vertically, but are spaced from each other.

Referring to the enlarged view of a part of FIG. 1, the worm 12 has a structure formed from PA12 resin 12a as a base and granular glass fiber 12b diffused in the PA12 resin 12a. For this purpose, the worm 12 may be formed, for example, through injection molding by employing a material obtained by mixing PA12 as the main component and glass fiber as a reinforcement component.

PA12 (or nylon 12) forming the main component of the material of the worm 12, and PA resins employed as the material of existing worms have physical properties indicated in Table 1 below.

TABLE 1

| Items | PA46 | PA66 | PA6 | PA610 | PA12 |
|---|---|---|---|---|---|
| Tensile strength (kgf/cm²) | 1000 | 780 | 750 | 600 | 460 |
| Elongation after fracture (%) | 40 | 60 | 60 | 200 | 250 |
| FM (kgf/cm²) | 32000 | 29000 | 24000 | 22000 | 15000 |
| Impact strength (kgf · cm/cm²) | 9 | 5 | 6 | 5 | 6 |
| Melting temperature (° C.) | 295 | 260 | 225 | 213 | 180 |
| Specific gravity | 1.18 | 1.14 | 1.13 | 1.09 | 1.6 |
| Saturated absorptance | 15.0 | 8.5 | 9.5 | 3.3 | 1.6 |

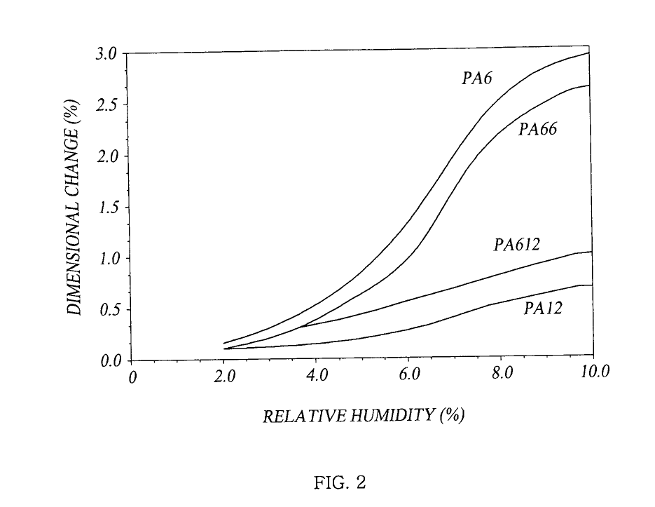

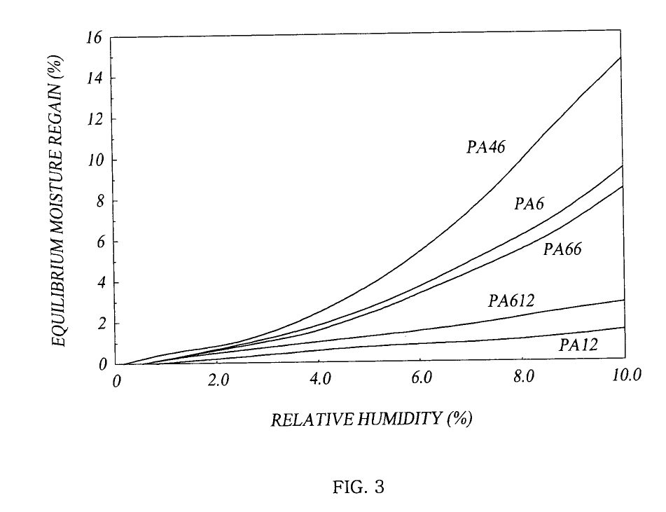

Referring to Table 1, PA12 has saturated moisture absorptance of about 1.6, which is substantially lower than those of other PA resins. A worm 12 formed from PA12 with low saturated moisture absorptance does not substantially suffer from deformation of teeth by moisture or humidity. If a reduction gear 10 including such a worm 12 and a worm wheel 14 is provided in an electric power steering apparatus and is used under a high humidity environment, increase in rotational torque caused by the deformation of the worm can be considerably suppressed. This can be confirmed from graphs shown in FIGS. 2 and 3, wherein FIG. 2 is a graph for relative humidity versus dimensional change rate of PA resins, and FIG. 3 is a graph for relative humidity versus equilibrium moisture regain.

Referring to Table 1 again, P12A has high elongation after fracture, good impact resistance and wear resistance, as well as superior moisture absorptance. Although PA12 is relatively poor in strength, its strength can be reinforced by glass fiber 12b.

According to the present invention, the worm 12 is formed from a material including PA in the range of 70 to 95 wt % and glass fiber in the range of 5 to 30 wt %, more preferably from a material including PA in the range of 80 to 90 wt % and glass fiber in the range of 10 to 20 wt %. Preferably, the glass fiber includes staple fibers with a length in the range of 3 to 4 mm and a diameter of 10 μm. In addition, it is possible to add a small quantity of additive, such as lubricant instead of reducing the quantity of PA12 or glass fiber.

Table 2 indicates in comparison Example 1, in which a worm 12 is formed from a material including PA12 of 70 wt % and glass fiber of 30 wt %, and Comparative Example 1, in which a worm is formed from PA12 of 100 wt %.

TABLE 2

| | | Glass | Tensile | Impact |
|---|---|---|---|---|
| | PA12 | fiber | strength | strength |
| Item | (wt %) | (wt %) | (kgf/cm²) | (kgf · cm/cm²) |
| Example 1 | 70 | 30 | 1010 | 6 |
| Comparative Example 1 | 100 | 0 | 460 | 18.7 |

As can be seen from Table 2, a worm 12 containing PA12 as the main component and reinforced by glass fiber of 30 wt % has high tensile strength and impact strength. In addition, PA12 reinforced by glass fiber of 30 wt % is superior in strength as compared other PA resins, i.e. PA46, PA6, PA66 and PA610.

However, the worm 12 is poor in wear resistance when it is reinforced by the glass fiber of 30 wt %. Therefore, it is desired to limit the content of glass fiber in the range of 10 to 20 wt %. As such, it is possible to improve the wear resistance of the worm without substantially deteriorating the tensile strength and impact strength of the worm. In addition, the content of glass fiber in this range will not substantially affect the moisture absorptance of PA12.

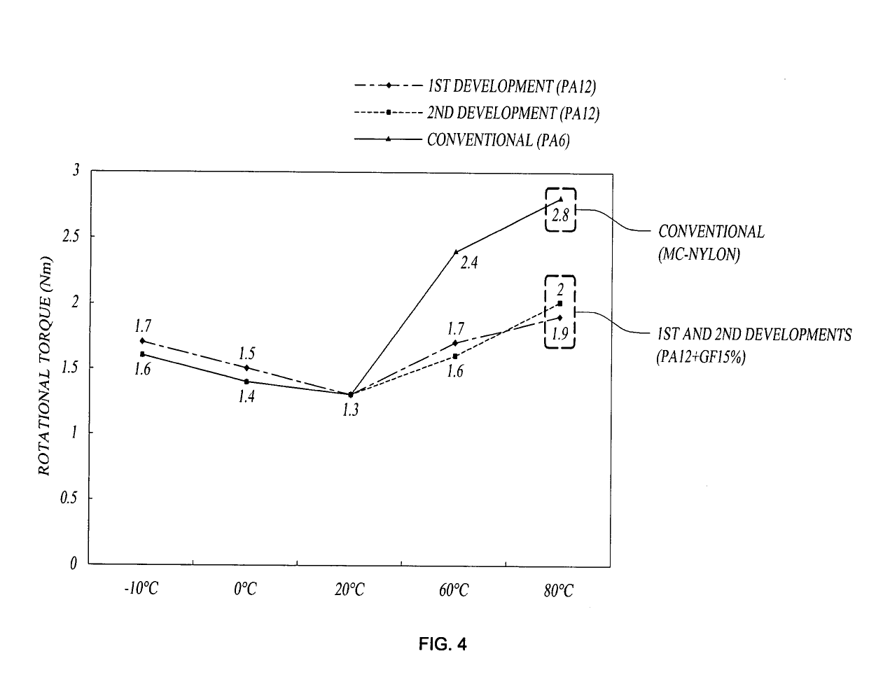

FIG. 4 is a graph showing the test results concerning change in rotational torque in worms (firstly and secondarily developed worms) formed from a material containing PA12 as main component and glass fiber of 15 wt % according to a preferred embodiment of the present invention. The graph also shows test results concerning change in rotational torque in a conventional worm formed from PA6 (MC-Nylon). Each of the rotational torques was measured immediately after leaving each worm as it is at each predetermined temperature for two hours under a given test condition. To be exact, the 30° C. measurement results in the graph of FIG. 4 are the results obtained through measurement at a temperature of 30.5° C. and at a humidity of 65%. Referring to FIG. 4, it can be found that in a low temperature region, there is little change in rotational torque in all of the inventive worms and the conventional worm, and that in a high temperature region, the inventive worms do not substantially suffer from change in rotational torque, whereas the conventional worm suffers from change in rotational torque.

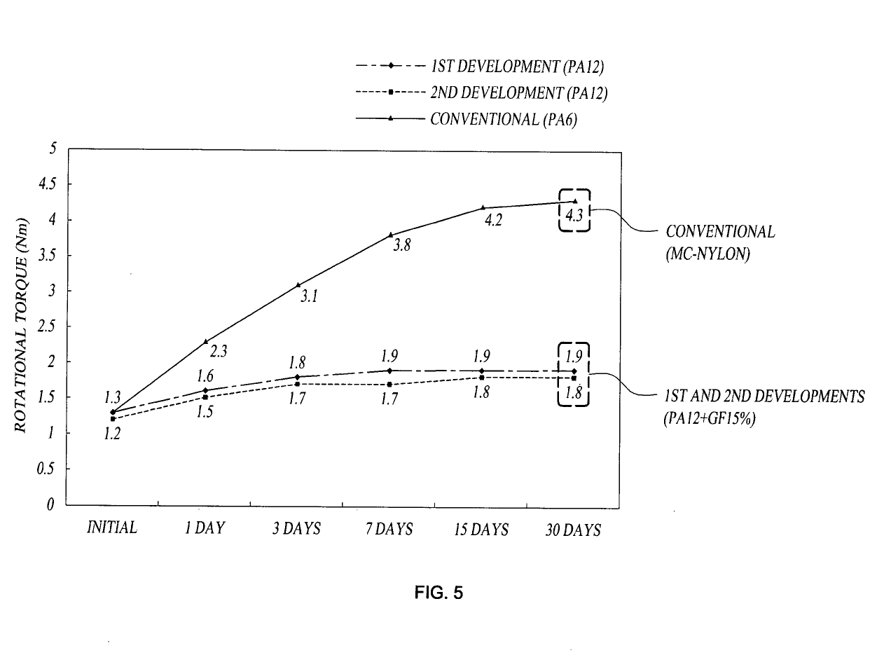

FIG. 5 is a graph showing test results concerning change in rotational torque in worms formed from a material containing PA12 as the main component and glass fiber of 15 wt %, in relation to moisture absorption of the worms. The tests were performed after leaving each of the worms as it is at a humidity of 95%. Referring to FIG. 5, it can be found that the inventive worms do not substantially suffer from change in rotational torque until 30 days have passed from the start of tests. However, the conventional worm formed from PA6 (MC-Nylon) provided as a comparative example suffers substantial change in torque as time passes.

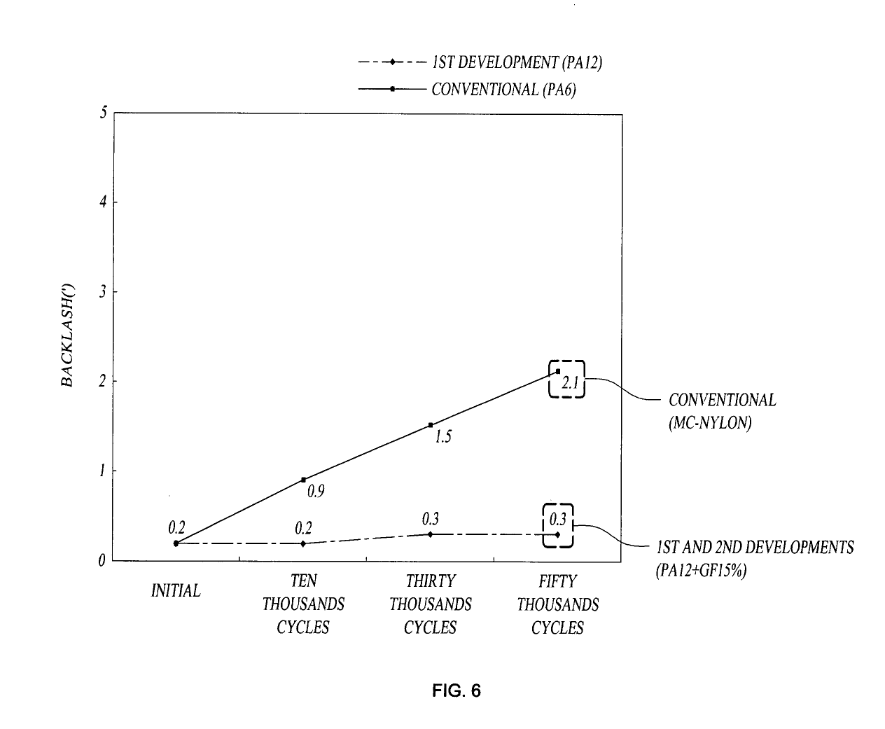

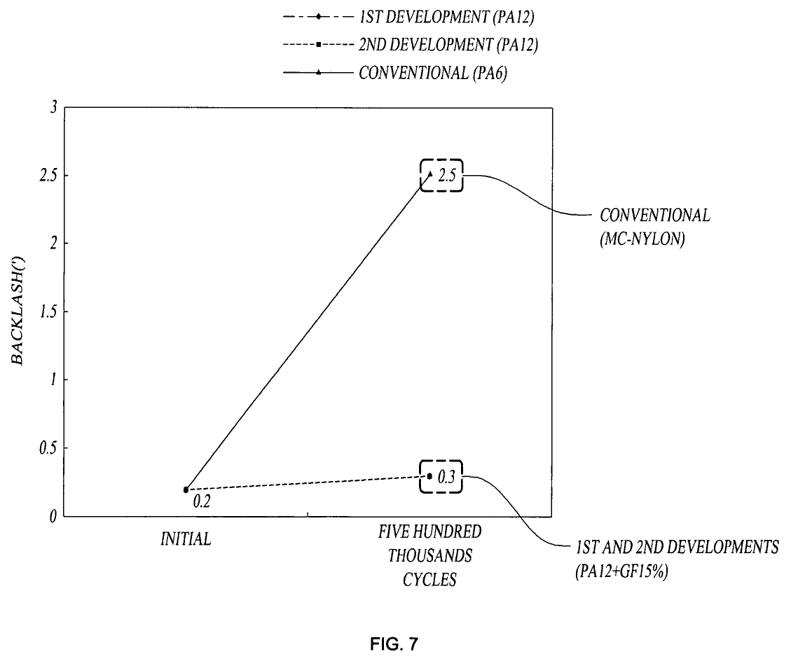

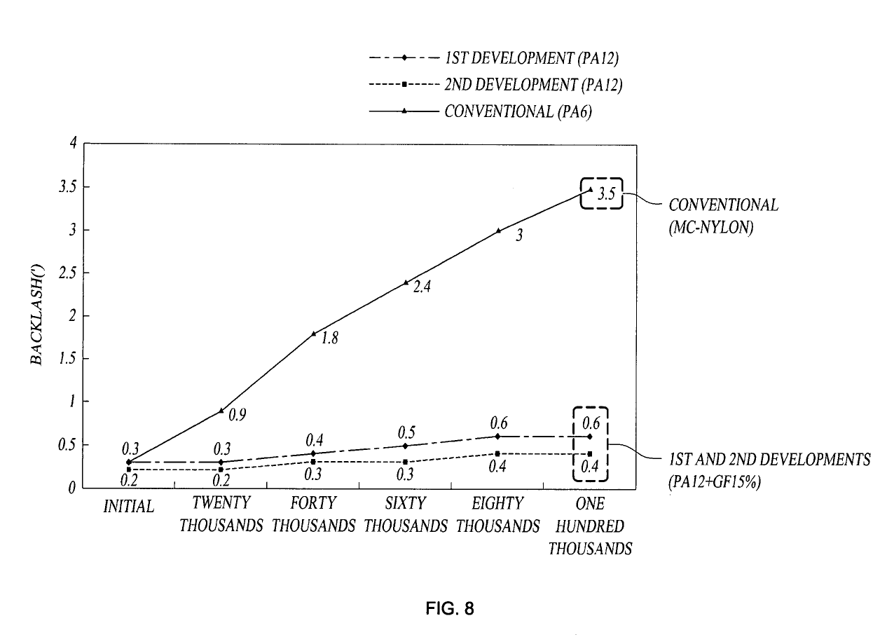

FIGS. 6 to 8 are graphs showing test results concerning change in backlash in the inventive worms, wherein FIG. 6 shows change in backlash of each worm after having undergone endurance tests in a complete assembly, FIG. 7 shows change in backlash after having undergone a fatigue test, and FIG. 8 shows change in backlash after having undergone endurance tests in a reduction gear. The conditions in the backlash change tests in FIG. 7 are as follows: temperature—room temperature, load—16.2 Nm, input shaft—fixed, velocity—2 Hz, and endurance cycles—100,000 cycles. The conditions in the backlash change tests in FIG. 8 are as follows: temperature—room temperature, load—45.6 Nm, velocity—10 CPM, endurance cycles—100,000 cycles.

From FIGS. 6 to 8, it can be confirmed that the inventive worms, i.e. the worms containing PA12 as the main component and glass fiber of 15 wt %, suffer from substantially smaller change in backlash as compared to the conventional worm.

As described above, in the inventive reduction gear for an electric power steering apparatus, i.e. the reduction gear including a worm formed from a material containing PA12 as main component and glass fiber as reinforcement component, and a worm wheel engaging with the worm, the worm is superior in dimensional stability in connection with temperature, as well as humidity or moisture, and the worm teeth do not substantially deform. Therefore, the reduction gear does not substantially suffer from change in rotational torque, even if the reduction gear is used for a long time under a high humidity environment. In addition, although PA12 with relatively low strength is used for forming the worm, the worm is not substantially poor in strength because it is reinforced by glass fiber.

According to the present invention, it is possible to provide a reduction gear for an electric power steering apparatus, wherein the worm of the reduction gear does not substantially suffer from dimensional deformation caused by moisture absorption and increase of rotational torque caused by the dimensional deformation without substantially deteriorating the strength and wear resistance as compared to those of a conventional worm.

Although a preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A reduction gear for an electric power steering apparatus for reducing and transmitting power of a motor to a steering shaft, comprising:
a worm wheel formed from a metallic material; and
a worm installed to engage with the worm wheel, the worm being formed from a material containing PA12 as a main component and glass fiber as a reinforcement component.

2. The reduction gear as claimed in claim 1, wherein the material of the worm comprises PA12 in the range of 70 to 95 wt % and glass fiber in the range of 5 to 30 wt %.

3. The reduction gear as claimed in claim 1, wherein the material of the worm comprises PA12 in the range of 80 to 90 wt % and glass fiber in the range of 10 to 20 wt %.

4. The reduction gear as claimed in claim 2 or 3, wherein the glass fiber has a length in the range of 3 to 4 mm and a diameter of 10 μm.
